(19) United States
(12) Patent Application Publication
(10) Pub. No.: US 2010/0312978 A1
(43) Pub. Date: Dec. 9, 2010

(54) COMPUTER SYSTEM, INFORMATION PROTECTION METHOD, AND PROGRAM

(75) Inventor: Tatsuya Ishizaki, Kanagawa (JP)

Correspondence Address: YOUNG & THOMPSON, 209 Madison Street, Suite 500, Alexandria, VA, 22314, US

(73) Assignee: NEC ELECTRONICS CORPORATION, KANAGAWA (JP)

(21) Appl. No.: 12/788,422

(22) Filed: May 27, 2010

(30) Foreign Application Priority Data
Jun. 5, 2009 (JP) 2009-136500

(51) Int. Cl. G06F 12/14; G06F 12/00; G06F 12/02

(52) U.S. Cl. 711/163; 711/103; 711/E12.001; 711/E12.008; 711/E12.093

(57) ABSTRACT

A computer system increases the confidentiality of a memory to be protected and prevents invalid access that is made, for example, by replacing the memory. The computer system includes a memory in which state information AA, which indicates whether or not information to be protected is stored in a predetermined memory area, and access permission information BB, which indicates whether or not access to the memory area is permitted, are stored; and an access control unit that rewrites the state information AA when information to be protected is written to, or deleted from, the memory area and at the same time, when the system is started, rewrites the access permission information BB to permit access to the memory area if information to be protected is not written in the memory area but, otherwise, rewrites the access permission information BB to the access inhibition state.

### CROSS-REFERENCE TO RELATED APPLICATION

This application is based upon and claims the benefit of the priority of Japanese patent application No. 2009-136500 filed on Jun. 5, 2009, the disclosure of which is incorporated herein in its entirety by reference thereto.

### TECHNICAL FIELD

The present invention relates to a computer system, an information protection method, and a program, and more particularly to a computer system, an information protection method, and a program that provides the function to protect information stored in the memory.

### BACKGROUND

An EEPROM (Electrically Erasable Programmable Read-Only Memory) or a ROM (Read-Only Memory) is used to store data and application programs. In particular, an EEPROM is used in most microprocessors to store data and application programs.

Many of those microprocessors are designed to enter the test mode to check if the operation is performed properly.

In the test mode, an external device has access to all data stored in the EEPROM or the ROM. In addition, instead of executing the test mode start operation, the microprocessor may also be programmed to enter the test mode and, in that case, there is a risk that the data and the application programs stored in the EEPROM or the ROM are read.

To overcome the problem described above, the configuration is known in which a security bit is provided in the EEPROM to protect data stored in the EEPROM or ROM.

This security bit is an index indicating one of two states, active and non-active. Data access is inhibited in the active state, and is permitted in the non-active state.

Patent Document 1 discloses a memory system that comprises a non-volatile EEPROM, a ROM, a bootstrap ROM, and a CPU and that has the security bit (SEC) described above as well as a security byte (VALSEC).

More specifically, when SEC indicates the active state, the memory system in Patent Document 1 limits access to the EEPROM shown in FIG. 1 of the document. In addition, when both SEC and VALSEC indicate the active state, the memory system disclosed in Patent Document 1 limits access to the EEPROM as well as to the ROM and the bootstrap ROM.

The memory system disclosed in Patent Document 1 uses SEC and VALSEC as described above to limit access to the EEPROM, the ROM, and the bootstrap ROM for inhibiting an unauthorized user from performing the test mode operation via the bootstrap program and, thereby, ensures the confidentiality of data such as that of the programs stored in the ROM.

[Patent Document 1] Japanese Patent Kokai Publication No. JP-A-3-71356

### SUMMARY

The entire disclosure of the above patent document is incorporated herein by reference thereto. The following analysis is given by the present inventor.

However, one of the problems with the memory system disclosed in Patent Document 1 given above is that, in order to inhibit an unauthorized user from using the test mode, the security bit (SEC), provided for determining whether to permit access to the EEPROM or the bootstrap ROM, must be written in advance from outside the memory system into the EEPROM (the bottom left column on page 4 of the document includes the description stating that “after the first test of the microprocessor device, the security bit SEC is usually programmed by the user to put it in the active state”).

Another problem with the memory system in Patent Document 1 given above is that, if the EEPROM is replaced by an EEPROM in which the security bit (SEC) is not yet written, the user is allowed to enter the bootstrap mode and, as a result, allowed to access the ROM and the bootstrap ROM. Thus there is much to be desired in the art.

According to a first aspect of the present invention, there is provided a computer system comprising a memory in which state information and access permission information are stored, the state information indicating whether or not information to be protected is stored in a predetermined memory area, the access permission information indicating whether or not access to the memory area is permitted; and an access control unit that rewrites the state information when information to be protected is written to, or deleted from, the memory area and at the same time, and when the system is started, rewrites the access permission information to permit access to the memory area if information to be protected is not written in the memory area and, otherwise, rewrites the access permission information to an access inhibition state.

According to a second aspect of the present invention, there is provided an information protection method for use in a computer system in which state information and access permission information are stored, the state information indicating whether or not information to be protected is stored in a predetermined memory area, the access permission information indicating whether or not access to the memory area is permitted. The information protection method comprises: rewriting the state information when information to be protected is written to, or deleted from, the memory area; and when the system is started, rewriting the access permission information to an access permission state if the state information indicates that information to be protected is not written in the memory area and, otherwise, rewriting the access permission information to an access inhibition state.

According to a third aspect of the present invention, there is provided a computer readable program for execution on a computer system in which state information and access permission information are stored, the state information indicating whether or not information to be protected is stored in a predetermined memory area, the access permission information indicating whether or not access to the memory area is permitted, the program causing the computer system to execute processing of rewriting the state information when information to be protected is written to, or deleted from, the memory area. When the system is started, the system is caused to execute: processing of rewriting the access permission information to an access permission state if the state information indicates that information to be protected is not written in the memory area and, otherwise, processing of rewriting the access permission information to an access inhibition state.

The meritorious effects of the present invention are summarized as follows.

The present invention increases the confidentiality of a memory area to be protected and prevents invalid access that is made, for example, by replacing the memory. The reason is that the system is configured in such a way that the access permission information is rewritten not manually but automatically when information to be protected is stored.

### BRIEF DESCRIPTION OF THE DRAWINGS

FIG. 1 is a block diagram showing the configuration of a first exemplary embodiment of the present invention.

FIG. 2 is a flowchart showing the operation of the first exemplary embodiment of the present invention.

FIG. 3 is a block diagram showing the configuration of a modified exemplary embodiment of the present invention.

FIG. 4 is a flowchart showing the operation of the modified exemplary embodiment of the present invention.

### PREFERRED MODES

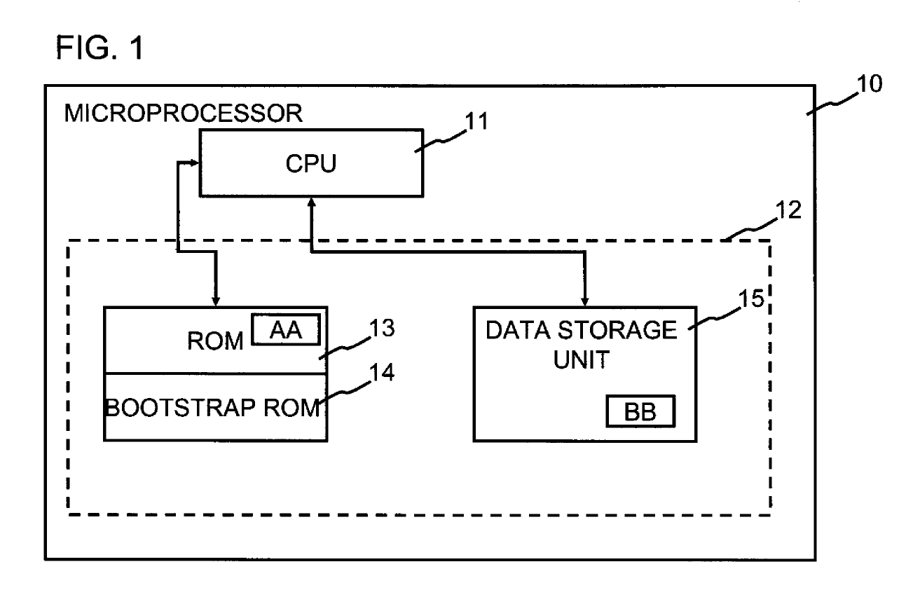

First, the following describes the overview of the present invention. The present invention comprises a memory that stores the state information (AA in FIG. 1) indicating whether information to be protected is stored in a predetermined memory area and the access permission information (BB in FIG. 1) indicating whether or not access to the memory area is permitted; and an access control unit (CPU in FIG. 1) that rewrites the state information (AA in FIG. 1) and the access permission information (BB in FIG. 1) to control access to the memory.

The access control unit (CPU in FIG. 1) rewrites the state information (AA in FIG. 1) when information to be protected is written into, or deleted from, the memory area. In addition, when the system is started, the access control unit (CPU in FIG. 1) references the state information (AA in FIG. 1) to set up the access permission information (BB in FIG. 1) as follows. That is, if information to be protected is not written in the memory area, the access control unit rewrites the access permission information to permit access to the memory area; otherwise, the access control unit rewrites the access permission information to inhibit access to the memory area. After that, while the system is in operation, the access control unit controls access to the memory area according to the access permission information.

Instead of manually rewriting the access permission information, the access control unit (CPU in FIG. 1) rewrites the access permission information according to the value of the state information as described above. Therefore, even if an unauthorized user tries to rewrite the access permission information, or replace the memory, from outside the computer system, the access control unit (CPU in FIG. 1) changes the value of the access permission information to the proper value, thus preventing access (invalid access) that is not intended by the user who wrote the program in the memory.

### [First Exemplary Embodiment]

Next, a first exemplary embodiment of the present invention will be described more in detail with reference to the drawings. FIG. 1 is a block diagram showing the configuration of the first exemplary embodiment in which the present invention is implemented on a microprocessor.

Referring to FIG. 1, the configuration comprises a CPU (Central Processing Unit) 11 that functions as the access control unit and an EEPROM (Electrically Erasable Programmable Read-Only Memory) 12.

The EEPROM 12 comprises a ROM (Read-Only Memory) 13 in which various programs are stored, a bootstrap ROM 14 in which the bootstrap program is stored, and a data storage unit 15 in which various data is stored. The term “ROM” in the ROM 13 and the bootstrap ROM 14 is used in the sense that those memories are read-only memories where once-written data is not basically rewritten. Note that the term “ROM” does not mean that those memories cannot be electrically rewritten.

In this exemplary embodiment, assume that the information to be protected is program data stored in the ROM 13. The ROM 13 has an area that stores the state information AA indicating whether or not program data is stored. The active state “1” of the state information AA indicates that program data is stored in the ROM 13, and the non-active state “0” of the state information AA indicates that program data is not stored in the ROM 13.

The data storage unit 15 in the EEPROM 12 has an area that stores the access permission information BB. The active state “1” of the access permission information BB indicates that access to the EEPROM 12 (ROM 13, bootstrap ROM 14, data storage unit 15) is inhibited, and the non-active state “0” of the access permission information BB indicates that access to the EEPROM 12 (ROM 13, bootstrap ROM 14, data storage unit 15) is permitted. Unlike the security bit described in Patent Document 1, the access permission information BB in this exemplary embodiment cannot be changed from outside the computer system.

The CPU 11 rewrites the state information AA when program data is written into, or deleted from, the ROM 13. In addition, when the system is started, the CPU 11 references the state information AA and, according to the value, updates the access permission information BB as will be described later and, based on the updated access permission information, controls access to the program data.

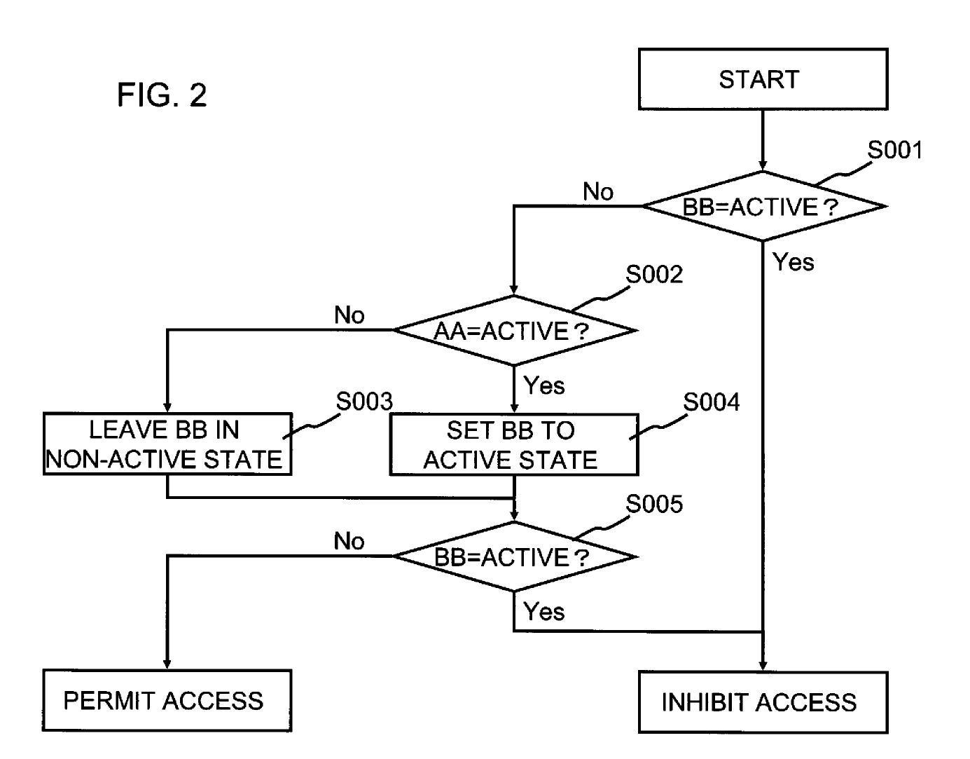

Next, the following describes the operation of the exemplary embodiment in detail with reference to the flowchart shown in FIG. 2. Referring to FIG. 2, the CPU 11 first checks the access permission information BB in the EEPROM 12 when the chipset operation is started (step S001).

If the access permission information BB indicates the active state as a result of the checking (Yes in step S001), the CPU 11 inhibits access to the EEPROM 12 (ROM 13, bootstrap ROM 14, and data storage unit 15).

On the other hand, if the access permission information BB indicates the non-active state, the CPU 11 reads the state information AA from the ROM 13 to check if the state information AA indicates the active state (step S002).

If the state information AA indicates the active state as a result of the checking (Yes in step S002), the CPU 11 changes the access permission information BB to the active state (step S004). That is, if the ROM 13 stores program data, the access permission information BB is updated to inhibit access to the program data thereafter.

On the other hand, if the state information AA indicates the non-active state (No in step S002), the CPU 11 leaves the access permission information BB in the non-active state (step S003). That is, when the ROM 13 does not store program data, the ROM 13 is left in the state in which program data may be written and the test may be carried out.

In this way, the CPU 11 reads the state information AA and determines if it is necessary to rewrite the access permission information BB based on the state of the state information AA and, if necessary, rewrites the access permission information BB. And, the next time the setup operation is performed, the CPU 11 reads the access permission information BB and, according to its value, determines if access to the EEPROM 12 (ROM 13, bootstrap ROM 14, data storage unit 15) is permitted.

As described above, the access permission information BB is rewritten in synchronization with the state information AA.

In this way, if the chipset operation is terminated with program data written at least once in the ROM 13, the access permission information BB in the EEPROM 12 becomes the active state the next time the chipset operation is started, and the access permission information BB is left in this state.

This prevents a user from accessing the EEPROM 12 (ROM 13, bootstrap ROM 14, data storage unit 15) and from entering the test mode, thereby increasing the confidentiality of the programs in the ROM 13.

On the other hand, if the chipset operation is terminated without writing a program in the ROM 13, the access permission information BB in the EEPROM 12 is left in the non-active state the next time the chipset operation is started. This allows a user to access the EEPROM 12 (ROM 13, bootstrap ROM 14, data storage unit 15) and to enter the test mode for carrying out the system operation test.

In this exemplary embodiment, if the program operation test is carried out with a program written in the ROM 13 and, after that, the program in the ROM 13 is erased and the chipset operation is terminated, the access permission information BB in the EEPROM 12 (ROM 13, bootstrap ROM 14, data storage unit 15) becomes the non-active state the next time the chipset operation is started. This offers benefits to both a manufacturer and a user. For example, the manufacturer can carry out the ROM operation test before shipment and, at the same time, the user can write a program in the ROM with confidentiality protection.

While the exemplary embodiment of the present invention has been described, it is to be understood that the present invention is not limited to the exemplary embodiment above and that further modifications, replacements, and changes may be added within the scope of the basic technical concept of the present invention. For example, though an example of the implementation using a microprocessor is described in the exemplary embodiment above, the present invention is applicable also to other general computer systems.

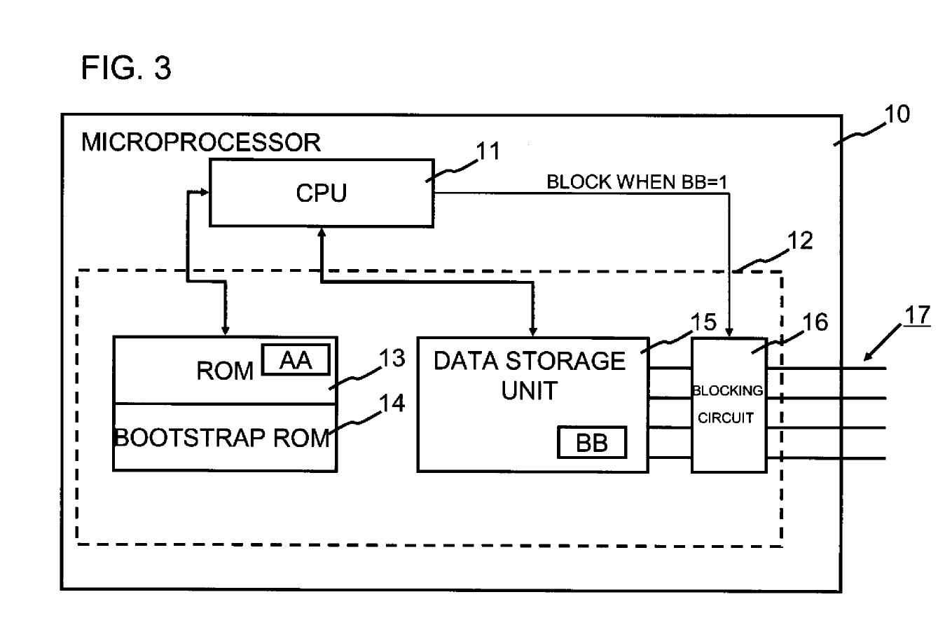

Although the control of the signal (transmission of the output signal that accesses the EEPROM 12) from the CPU 11 to the EEPROM 12 (ROM 13, bootstrap ROM 14, data storage unit 15) is limited to limit access to the EEPROM 12 in the exemplary embodiment described above, it is also possible to employ the configuration in which a blocking circuit 16 is provided that conducts or blocks test wiring lines 17 of the EEPROM 12 as shown in FIG. 3. This configuration allows the CPU 11 to send the blocking signal, or to stop sending the conducting signal, to the blocking circuit 16 for blocking the test wiring lines.

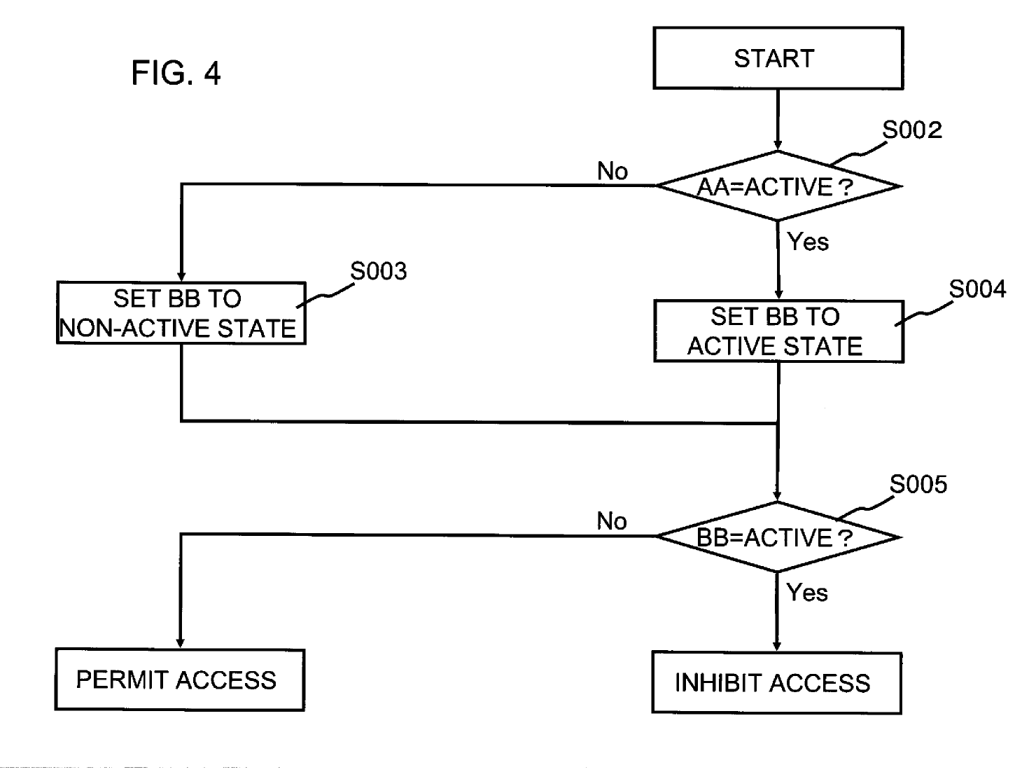

For example, though the access permission information BB is stored in the data storage unit 15 in the EEPROM 12 in the exemplary embodiment described above, another configuration is also possible in which the access permission information BB is stored in a volatile memory, such as an SDRAM (Synchronous Dynamic Random Access Memory), in which case the flow shown in FIG. 4 is used.

More specifically, the CPU 11 first reads the state information AA stored in the ROM 13 (step 5002) and, depending upon whether the state information AA indicates the active state, writes the access permission information BB in the SDRAM as shown in FIG. 4 (step S003, step S004). Immediately after that, the CPU 11 reads the access permission information BB (step 5005) and, depending upon whether the access permission information BB indicates the active state, determines whether to permit access to the bootstrap ROM 14 or the SDRAM.

For example, if the chipset operation is terminated with program data written at least once in the ROM 13, the state information AA is updated to the active state. After that, when the next chipset operation is started with the state information AA in the active state, the access permission information in the SDRAM is rewritten to the active state and, so, a user cannot access the bootstrap ROM 14 and the SDRAM and cannot enter the test mode. This increases the confidentiality of the programs in the ROM 13.

On the other hand, if the chipset operation is terminated without writing a program in the ROM 13, the access permission information BB in the SDRAM is set to the non-active state the next time the chipset operation is started as in the first exemplary embodiment described above. This allows a user to access the bootstrap ROM 14 and the SDRAM and to enter the test mode for carrying out the system operation test.

According to the present invention, the access to the memory can be controlled efficiently also when the memory in which the access permission information BB is stored is a volatile memory.

Note that the access permission information BB, though one-bit information in the exemplary embodiment described above, may be multiple-bit information. For example, a modification of the exemplary embodiment is possible in which the access permission information BB is added up each time the test mode is started and, until the value of the access permission information BB reaches a predetermined value, the user is allowed to access the memory regardless of the state information AA.

Similarly, the state information AA may be multiple-bit information. For example, a modification of the present invention is possible in which the value is added up according to the type (importance), size, and number of data updates of the information to be stored and in which the access permission information BB is rewritten to the non-active state until the value of the state information AA reaches a predetermined value and is rewritten to the active state after the value reaches the predetermined value.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A computer system comprising:
a memory in which state information and access permission information are stored, said state information indicating whether or not information to be protected is stored in a predetermined memory area, said access permission information indicating whether or not access to said memory area is permitted; and
an access control unit that rewrites the state information when information to be protected is written to, or deleted from, said memory area and at the same time, and when the system is started, rewrites the access permission information to permit access to said memory area if information to be protected is not written in said memory area and, otherwise, rewrites the access permission information to an access inhibition state.

2. The computer system as defined by claim 1, wherein said access control unit limits access to said memory area by limiting an output signal that accesses the memory area or by blocking test wire lines.

3. The computer system as defined by claim 1, wherein
said memory is a non-volatile memory and
said access control unit first checks the access permission information when the system is started and, if the access permission information indicates the access inhibition state, inhibits data access to said memory area.

4. The computer system as defined by claim 1, wherein
if the access permission information indicates the access inhibition state, said access control unit further inhibits data access to a ROM (Read-Only Memory) and a bootstrap ROM provided by the unit.

5. An information protection method for use in a computer system in which state information and access permission information are stored, said state information indicating whether or not information to be protected is stored in a predetermined memory area, said access permission information indicating whether or not access to said memory area is permitted,
said information protection method comprising:
rewriting the state information when information to be protected is written to, or deleted from, said memory area; and
when the system is started, rewriting the access permission information to an access permission state if the state information indicates that information to be protected is not written in said memory area and, otherwise, rewriting the access permission information to an access inhibition state.

6. A computer readable program for execution on a computer system in which state information and access permission information are stored, said state information indicating whether or not information to be protected is stored in a predetermined memory area, said access permission information indicating whether or not access to said memory area is permitted;
said program causing said computer system to execute:
processing of rewriting the state information when information to be protected is written to, or deleted from, said memory area; and
when the system is started, processing of rewriting the access permission information to an access permission state if the state information indicates that information to be protected is not written in said memory area and, otherwise, processing of rewriting the access permission information to an access inhibition state.

7. The computer system as defined by claim 2, wherein
said memory is a non-volatile memory, and
said access control unit first checks the access permission information when the system is started and, if the access permission information indicates the access inhibition state, inhibits data access to said memory area.

8. The computer system as defined by claim 2, wherein
if the access permission information indicates the access inhibition state, said access control unit further inhibits data access to a Read-Only Memory ROM and a bootstrap ROM provided by the unit.

9. The computer system as defined by claim 3, wherein
if the access permission information indicates the access inhibition state, said access control unit further inhibits data access to a Read-Only Memory ROM and a bootstrap ROM provided by the unit.

10. The information protection method according to claim 5, further comprising:
limiting access to said memory area by limiting an output signal that accesses the memory area or by blocking test wire lines.

11. The information protection method according to claim 5, further comprising:
checking the access permission information when the system is started and, if the access permission information indicates the access inhibition state, inhibits data access to said memory area.

12. The information protection method according to claim 10, further comprising:
checking the access permission information when the system is started and, if the access permission information indicates the access inhibition state, inhibits data access to said memory area.

13. The information protection method according to claim 5, further comprising:
inhibiting data access to a Read-Only Memory ROM and a bootstrap ROM provided by the unit if the access permission information indicates the access inhibition state.

14. The information protection method according to claim 10, further comprising:
inhibiting data access to a Read-Only Memory ROM and a bootstrap ROM provided by the unit if the access permission information indicates the access inhibition state.

15. The information protection method according to claim 11, further comprising:
inhibiting data access to a Read-Only Memory ROM and a bootstrap ROM provided by the unit if the access permission information indicates the access inhibition state.
